(19) United States
(12) Patent Application Publication
(10) Pub. No.: US 2007/0066366 A1
(43) Pub. Date: Mar. 22, 2007

(54) Method and system for implementing an emergency alert receiver system in a cellular phone

(76) Inventor: Katherine Graham, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/229,288

(22) Filed: Sep. 16, 2005

(51) Int. Cl. H04M 11/04; H04B 1/38

(52) U.S. Cl. 455/567; 455/404.1

(57) ABSTRACT

A cellular phone includes a cellular section and an emergency alert system (EAS) section. The cellular section receives and transmits communications over a cellular network. The EAS section receives emergency alert messages independent of the cellular network. The emergency alert messages are then broadcast to a user.

### BACKGROUND

Emergency alert systems, such as the National Weather Radio (NWR) system, are used to alert individuals to various types of emergencies. The emergencies include weather hazards such as flooding and tornados, air quality hazards, and hazardous material leaks. An emergency message or alert tone is typically transmitted to activate an emergency alert receiver. An emergency alert receiver outputs an audible tone, an audible message, or flashes a warning light in response to receiving and decoding an emergency message or tone.

A person can easily miss an emergency alert message. Typically a person is required to watch the local television channels or listen to a radio to stay informed about threatening or emergency conditions. If a person does not have the television or radio turned on, or if the person is not within listening distance of the television or radio, the person can miss the alert message and lose critical time needed to respond to the alert message.

A siren is another technique used to alert individuals to emergency situations. A city or other geographical region installs the sirens at different locations throughout the area. Unfortunately, siren systems can be costly to install and maintain. And siren warnings can still be missed by a person. For example, a person may be sleeping when the siren is activated or watching television at a sound level that interferes with their hearing the siren.

### SUMMARY

In accordance with the invention, a method and system for implementing an emergency alert receiver system in a cellular phone are provided. A cellular phone includes a cellular section and an emergency alert system (EAS) section. The cellular section receives and transmits communications over a cellular network. The EAS section receives emergency alert messages independent of the cellular network. The emergency alert messages are then broadcast to a user.

### BRIEF DESCRIPTION OF THE DRAWINGS

FIG. 1 is a block diagram of a system for implementing an EAS in a cellular phone in an embodiment in accordance with the invention;

FIG. 2 is a flowchart of a method for configuring a cellular phone to receive an alert message in an embodiment in accordance with the invention;

FIG. 3 is a flowchart of a first method for receiving an alert message in a cellular phone in an embodiment in accordance with the invention;

FIG. 4 is a first block diagram of the system shown in FIG. 1 that may be used to implement the method of FIG. 3;

FIG. 5 is a flowchart of a second method for receiving an alert message in a cellular phone in an embodiment in accordance with the invention;

FIG. 6 is a second block diagram of the system shown in FIG. 1 that may be used to implement the method of FIG. 5.

### DETAILED DESCRIPTION

The following description is presented to enable one to make and use embodiments in accordance with the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

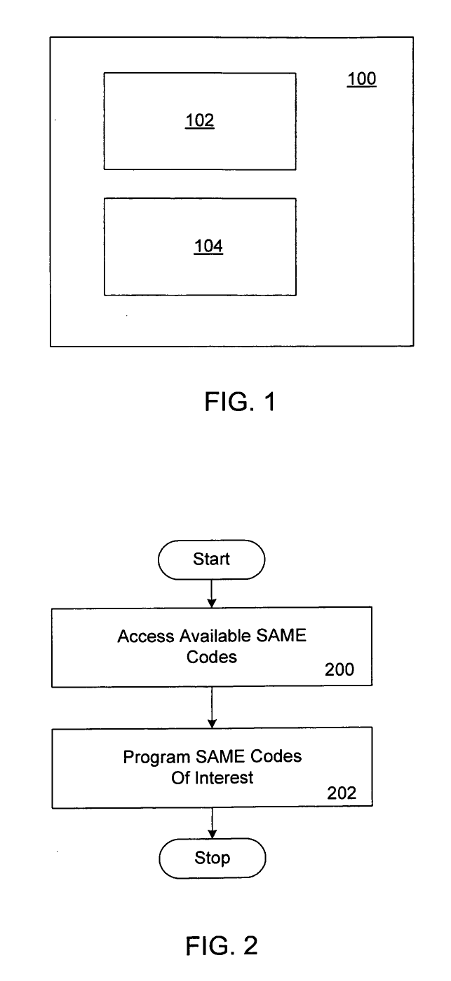

With reference to the figures and in particular with reference to FIG. 1, there is shown a block diagram of a system for implementing an EAS in a cellular phone in an embodiment in accordance with the invention. Cellular phone 100 includes cellular section 102 and EAS section 104. Cellular section 102 performs the functions associated with sending and receiving communications over a cellular or wireless network. EAS section 104 performs the functions associated with receiving and broadcasting emergency alert messages from an emergency alert system. EAS section receives the emergency alert messages independent of the cellular or wireless network in an embodiment in accordance with the invention.

EAS section 104 operates pursuant to the National Oceanic and Atmospheric Administration's National Weather Radio (NWR) system in an embodiment in accordance with the invention. Other embodiments in accordance with the invention may operate according to different emergency alert systems. The emergency alert systems may be governed by a country such as England and Japan, by a collection of countries such as the European Union, or by particular geographical regions such as states, counties, and cities.

The National Weather Radio (NWR) is a nationwide network of radio stations that broadcast continuous weather forecasts, warnings, and watches obtained directly from a National Weather Service office. The NWR is an “all hazards” radio network that broadcasts information regarding hazards such as tornados, earthquakes, hurricanes, air quality issues, and chemical hazards. Broadcasts are found in the public service band, which presently includes the seven frequencies of 162.400 MHz, 162.425 MHz, 162.450 MHz, 162.475 MHz, 162.500 MHz, 162.525 MHz, and 162.550 MHz.

FIG. 2 is a flowchart of a method for configuring a cellular phone to receive an alert message in an embodiment in accordance with the invention. The alert messages are broadcast over the NWR with Specific Area Message Encoding (SAME) codes in an embodiment in accordance with the invention. A SAME code is a digital burst of data that includes information on the type of message, the area affected, and the expiration time of the message.

Initially the available SAME codes are accessed by a user, as shown in block 200. The user then selects and programs his or her SAME codes of interest into the device, as shown in block 202. The user may access the available SAME codes in several ways. For example, the list may be included in a printed document or heard over a communications device such as a radio. The user reviews the list, selects the desired codes, and then programs the codes into the cellular phone. The desired codes are stored in the cellular phone by entering the codes into the cellular phone using the keyboard in an embodiment in accordance with the invention.

In another embodiment in accordance with the invention, the available SAME codes are downloaded from a network such as the Internet and stored in the cellular phone. The available codes may be displayed on the cellular phone to allow the user to select the desired codes. The selected codes are stored in the cellular phone by, for example, entering the codes into the cellular phone using the keyboard or highlighting the codes with a cursor.

The available codes may also be displayed on the cellular phone to allow the user to de-select or delete unwanted codes. The unwanted codes are deleted by, for example, entering the codes into the cellular phone using the keyboard or highlighting the codes with a cursor.

And in yet another embodiment in accordance with the invention, the codes are pre-stored in the cellular phone and displayed to the user on a display associated with the cellular phone. A manufacturer or retailer may store all available codes in the cellular phone or only those codes applicable to a particular area or region. Finally, other embodiments in accordance with the invention may store the codes in the cellular phone using different techniques.

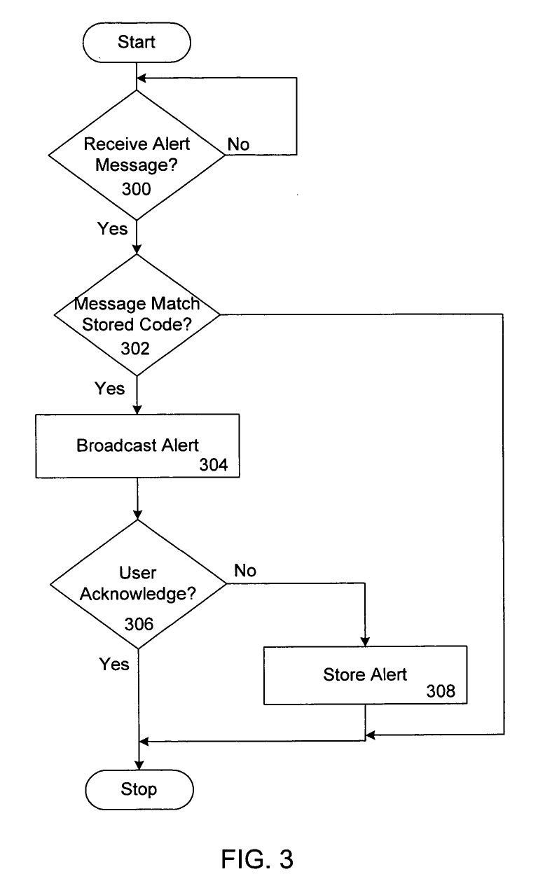

Referring to FIG. 3, there is shown a flowchart of a first method for receiving an alert message in a cellular phone in an embodiment in accordance with the invention. Initially a determination is made at block 300 as to whether an alert message is received. When an alert message is received, a determination is made as to whether the alert message or a portion of the alert message matches one of the emergency alert codes stored in the cellular phone (block 302). As discussed in conjunction with FIG. 2, the emergency alert codes are SAME codes and an emergency message includes a SAME code that corresponds to a particular type of alert message.

If the alert message or portion of the alert message matches a stored code, the alert message is broadcast, as shown in block 304. A determination is then made at block 306 as to whether the user has acknowledged the broadcast alert message. A user may acknowledge the alert message by, for example, pressing a button on the cellular phone. If the user does not acknowledge the alert message, the alert message is stored in the cellular phone (block 308).

Other embodiments in accordance with the invention may employ different blocks or omit one or more blocks from those shown in the embodiment of FIG. 3. For example, a system may omit blocks 306 and 308 and simply receive and broadcast the alert message according to blocks 300 through 304.

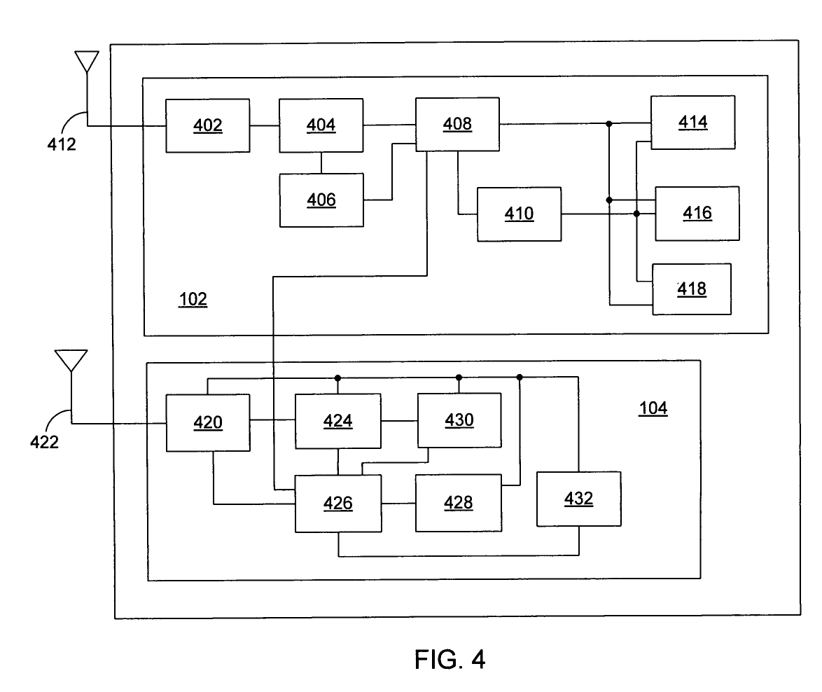

FIG. 4 is a first block diagram of the system shown in FIG. 1 that may be used to implement the method of FIG. 3. Cellular phone 400 includes cellular section 102 and EAS section 104. Cellular section 102 includes RF section 402, signal processing section 404, memory section 406, control section 408, and power source control section 410. RF section 402 receives an RF signal or generates and transmits an RF signal using antenna 412. RF section 402 also extracts signals addressed or intended for cellular phone 400 from the received RF signals.

Signal processing section 404 modulates the signals to be sent and demodulates the received signals. Signal processing section 404 also processes the received signals. Programs, control information, and data are stored in memory section 406. Control section 408 manages and controls operations of cellular section 102 in an embodiment in accordance with the invention. Control section 408 also provides an interface to display 414, speaker 416, and keyboard 418. And finally, power source control section 410 supplies power to the sections and components in cellular section 102 that require power.

RF section 420 in EAS section 104 receives an RF signal using antenna 422. Signal processing section 424 receives the signals and extracts the alert message from the RF signal. As discussed earlier, the alert message includes a SAME code in an embodiment in accordance with the invention. Control section 426 manages and controls operations of EAS section 104 in an embodiment in accordance with the invention. Power source control section 428 supplies power to the sections and components in EAS section 104.

Memory section 430 is accessed to obtain the stored SAME codes. Signal processing section 424 compares the SAME code extracted from the alert message with the stored SAME codes to determine whether the extracted SAME code matches one of the stored codes. When the extracted SAME code matches a stored code, the alert message is broadcast using speaker 432.

EAS section 104 receives and processes alert messages independent of cellular section 102 in an embodiment in accordance with the invention. However, one or more of the blocks shown in both cellular section 102 and EAS section 104 may be implemented as a single block in other embodiments in accordance with the invention. For example, power source control sections 410, 428 may be implemented as one power source control section that is used by both the cellular and EAS sections.

Moreover, two or more blocks may be implemented with one component in embodiments in accordance with the invention. For example, the functions and features associated with signal processing section 404 and control section 408 may be implemented in a single microprocessor.

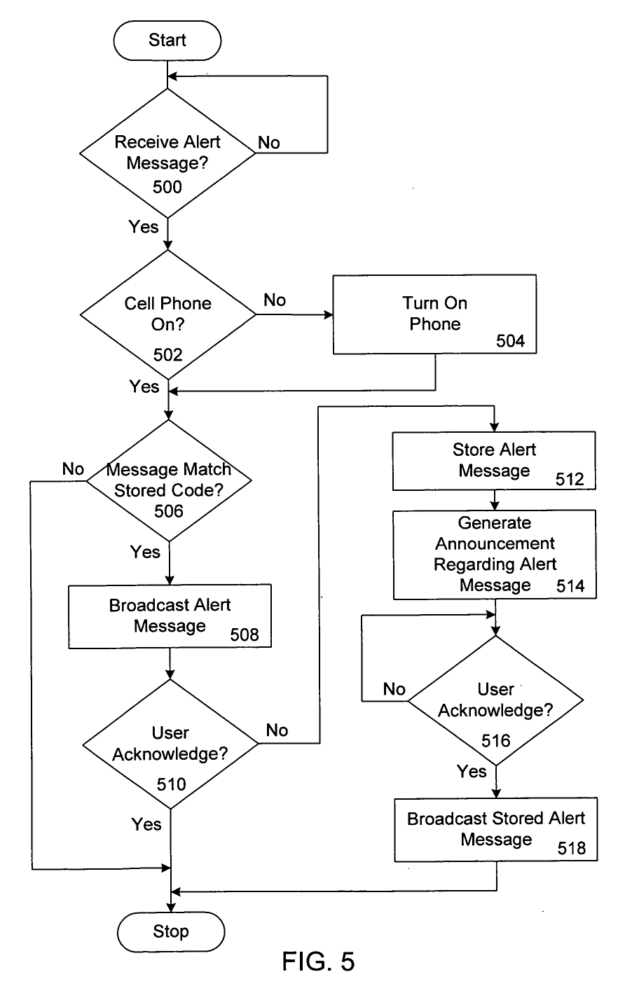

Referring to FIG. 5, there is shown a flowchart of a second method for receiving an alert message in a cellular phone in an embodiment in accordance with the invention. Initially a determination is made as to whether an alert message has been received, as shown in block 500. When an alert message is received, a determination is made as to whether the cellular phone is turned on (block 502). If not, the process passes to block 504 where the cellular phone is turned on.

When the cellular phone is on, a determination is made as to whether the alert message or a portion of the alert message matches one of the emergency alert codes stored in the cellular phone (block 506). As discussed in conjunction with FIG. 2, the emergency alert codes are SAME codes and an emergency message includes a SAME code that corresponds to a particular type of alert message.

If the alert message or portion of the alert message matches a stored code, the alert message is broadcast, as shown in block 508. The alert message is broadcast to the user audibly using a speaker in the cellular phone in an embodiment in accordance with the invention. In other embodiments in accordance with the invention, the alert message may be broadcast visually, such as a text message, or with a combination of techniques.

After the alert message is broadcast at block 508, a determination is made as to whether or not the user has acknowledged the message (block 510). If not, the alert message is stored and an announcement regarding the alert message is generated (blocks 512, 514). The announcement is an audible notice, such as a period beep generated by the cellular phone, in an embodiment in accordance with the invention. In other embodiments in accordance with the invention, the announcement is implemented differently, such as, for example, as a displayed text message or icon or a periodic vibration.

A determination is then made at block 516 as to whether the user has acknowledged the announcement. If not, the process waits until the user acknowledges the announcement. When the user acknowledges the announcement, the method continues at block 518 where the stored alert message is read from memory and broadcast to the user.

Other embodiments in accordance with the invention may employ different blocks or omit one or more blocks from those shown in the embodiment of FIG. 5. For example, a system may omit blocks 510-518 and simply receive and broadcast the alert message pursuant to blocks 500-508.

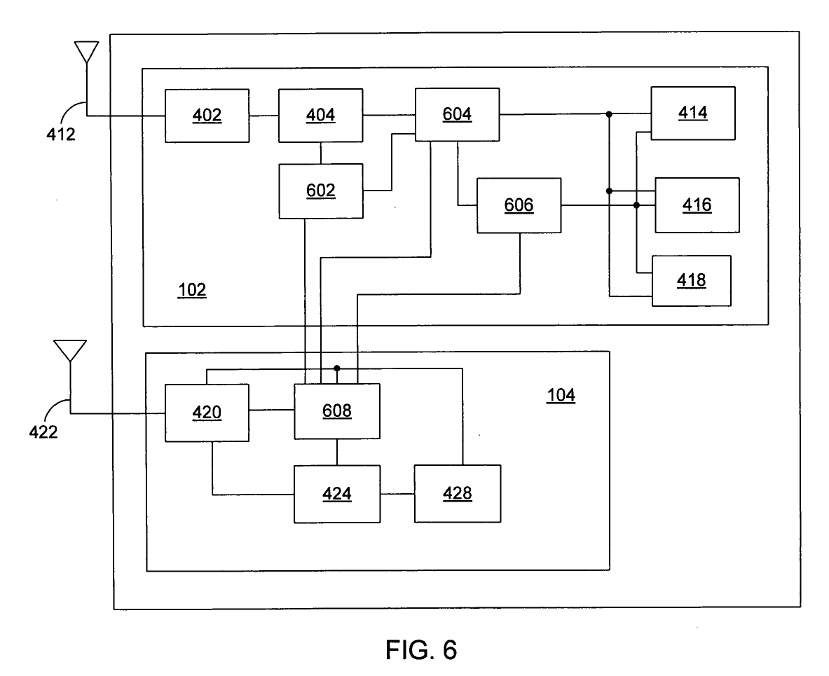

FIG. 6 is a second block diagram of the system shown in FIG. 1 that may be used to implement the method of FIG. 5. Cellular phone 600 includes cellular section 102 and EAS section 104. The same reference numbers are used in FIG. 6 for those blocks that perform similar functions as the blocks in FIG. 4.

Cellular section 102 includes RF section 402, signal processing section 404, memory section 602, control section 604, and power source control section 606. Programs, control information, and data are stored in memory section 602. Memory section 602 also stores SAME codes in an embodiment in accordance with the invention.

Control section 604 manages and controls operations of cellular section 102 in an embodiment in accordance with the invention. Control section 604 also provides an interface to display 416, speaker 418, and keyboard 420. And finally, power source control section 606 supplies power to those sections and components in cellular section 102 that require power.

EAS section 104 includes RF section 420, signal processing section 424, control section 608, and power source control section 428. Signal processing section 424 receives the signals from RF section 420 and extracts the alert message from the signal. Control section 608 determines whether power source control section 606 in cellular section 102 is supplying power to cellular section 102. If not, control section 608 activates power source control section 606 and accesses memory section 602 to obtain the stored SAME codes.

Signal processing section 424 compares the extracted SAME code with the stored SAME code or codes to determine whether the extracted SAME code matches one of the stored codes. When the extracted SAME code matches a stored SAME code, control section 608 transmits the alert message to control section 606 to broadcast the alert message with speaker 418. In other embodiments in accordance with the invention, the alert message is broadcast differently. For example, the alert message may be displayed as a text message or icon.

EAS section 104 receives and broadcasts alert messages in conjunction with cellular section 102 in an embodiment in accordance with the invention. As with the embodiment shown in FIG. 4, one or more of the blocks shown in both cellular section 102 and EAS section 104 may be implemented as a single block. And two or more blocks may be implemented with one component in embodiments in accordance with the invention.

The embodiments of the invention shown in FIGS. 2-6 have been described as operating pursuant to the National Oceanic and Atmospheric Administration's National Weather Radio (NWR) system. As discussed earlier, other embodiments in accordance with the invention may operate according to different emergency alert systems. The emergency alert systems may be governed by a country, by a collection of countries, or by particular geographical regions.

1. A cellular phone, comprising:
a cellular section operable to send and receive a signal over a cellular network; and
an emergency alert system section operable to receive an alert signal independent of the cellular network, wherein the alert signal comprises an emergency alert message.

2. The cellular phone of claim 1, wherein the cellular section comprises:
an RF section operable to receive the signal; and
a speaker connected to a power source control section and a control section.

3. The cellular phone of claim 2, wherein the speaker is operable to broadcast the emergency alert message.

4. The cellular phone of claim 2, wherein the cellular section further comprises a keyboard and a display.

5. The cellular phone of claim 4, wherein the display is operable to display the emergency alert message.

6. The cellular phone of claim 2, wherein the cellular section further comprises memory operable to store one or more emergency alert codes.

7. The cellular phone of claim 1, wherein the emergency alert system section comprises:
an RF section operable to receive the alert signal;
a signal processing section operable to receive the alert signal from the RF section and obtain an emergency alert code from the emergency alert message; and
a power source control section operably connected to the RF section and the signal processing section.

8. The cellular phone of claim 7, wherein the emergency alert system section comprises memory operable to store one or more emergency alert codes.

9. The cellular phone of claim 7, wherein the emergency alert system section further comprises a speaker operable to broadcast an emergency alert message.

10. A method for operating an emergency alert system in a cellular phone, comprising:
transmitting and receiving cellular communications using a wireless cellular network;
receiving an emergency alert message from an emergency alert system independent of the wireless cellular network; and
broadcasting the emergency alert message.

11. The method of claim 10, further comprising:
determining whether a user has acknowledged the broadcasted emergency alert message; and
storing the emergency alert message if the user has not acknowledged the broadcasted emergency alert message.

12. The method of claim 11, further comprising generating an announcement in response to storing the emergency alert message.

13. The method of claim 12, further comprising determining whether the user has acknowledged the announcement.

14. The method of claim 13, wherein broadcasting the emergency alert message comprises broadcasting the emergency alert message in response to the user acknowledging the announcement.

15. The method of claim 10, further comprising:
determining whether the cellular phone is turned on prior to broadcasting the emergency alert message; and
turning on the cellular phone prior to broadcasting the emergency alert message.

16. The method of claim 10, further comprising storing one or more emergency alert codes prior to receiving an emergency alert message from an emergency alert system.

17. The method of claim 10, wherein broadcasting the emergency alert message comprises:
accessing the one or more stored codes;
comparing an emergency alert code included in the emergency alert message with the one or more stored emergency alert codes; and
broadcasting the emergency alert message when the emergency alert code included in the emergency alert message matches one of the stored emergency alert codes.

18. The method of claim 17, wherein the emergency alert codes comprise Specific Area Message Encoding (SAME) codes.
